(19) United States
(12) Patent Application Publication
(10) Pub. No.: US 2011/0298631 A1
(43) Pub. Date: Dec. 8, 2011

(54) PORTABLE HEAD OF BED ALERT DEVICE

(76) Inventors: Stephen Anthony Tunnell, Oceanside, CA (US); David Conrad Willms, Del Mar, CA (US); David John Bennett, Oceanside, CA (US)

(21) Appl. No.: 13/107,662

(22) Filed: May 13, 2011

Related U.S. Application Data
(60) Provisional application No. 61/334,382, filed on May 13, 2010.

(51) Int. Cl. G08B 21/00

(52) U.S. Cl. 340/689

(57) ABSTRACT

An alert device is positioned on a bed, such as on the head region of the bed. The alert device is configured to detect or otherwise measure the angle of orientation of the head region such as relative to the horizontal plane. The alert device is configured to provide an alert when the angle orientation of the head region falls outside a predetermined value or range of values. The alert may be any audio, visual, or tactile means of notifying a user as to an alarm condition.

### REFERENCE TO PRIORITY DOCUMENT

This application claims priority of co-pending U.S. Provisional Patent Application Ser. No. 61/334,382, filed on May 13, 2010. The disclosure of the Provisional Patent Application is hereby incorporated by reference in its entirety.

### BACKGROUND

The present disclosure relates to head of bed elevation, which is important in the medical environment where patients are managed with artificial airways, receive tube feedings, and mechanically ventilated.

Many health organizations have long recognized that maintaining head of bed elevation or semi-recumbent positioning in patients under mechanical ventilation can reduce the incidence of aspiration and Ventilator Associated Pneumonia. Several other clinical conditions, such as for example brain injury and elevated intracranial pressure, also require head of bed elevation. Despite compelling clinical rationale against such positions, patients are often left in a supine position and predisposed to aspiration of oral and gastro-intestinal contents.

Because of this issue many health care governance organizations such as Joint Commission on Accreditation of Health Care Organizations and the Institute for Health Care Improvement have called for head of bed elevation as a quality measure. Some medical device manufacturers have developed devices to assist the caregiver in measuring and maintaining the head of bed position. As an example many bed manufacturers have integrated inclinometers to visually indicate the actual head of bed angle of elevation with respect to gravity. Others have placed tracks to pull a numeric angle indicator showing the head of bed angle with respect to the remaining base of the bed, which lies parallel to the floor. Others have implanted ball inclinometers into the rails of the bed which attach to the head of bed and thus allow the user to read the actual angle in respect of gravity.

Others have developed angle indicator systems that comprise an indicator with an angular range of motion enclosed in a housing with marking to show the angulations of the structure, in this case the head of bed, with respect to a plane, in this case the base structure of the bed. The latter device has been both described as mountable to the structure as well as integrated into the structure. Unfortunately all of these devices require visual observation of the head of bed angle and all of these devices have angle indicators and angle markings for the observers. Some of these bed integrated devices provide sophisticated electronic communication systems which are expensive and require uniformity of the hospitals information system.

### SUMMARY

In view of the foregoing, there is a need for improved devices and methods for managing head of bed elevation in a patient.

In one aspect, there is disclosed a bed alert device, comprising: a housing adapted to be removably attached to a patient support member, wherein the patient support member includes a support region that is movable between multiple angular orientations; an angle measurement member coupled to the housing and configured to measure the angular orientation of the support region; and an alarm emitter coupled to the angle measurement member and configured to emit an alarm when the angular orientation falls outside a predetermined angle.

Other features and advantages should be apparent from the following description of various embodiments, which illustrate, by way of example, the principles of the invention.

### BRIEF DESCRIPTION OF THE DRAWINGS

FIG. 1 shows a schematic view of a bed.

FIG. 2 shows an exemplary bed alert device.

FIGS. 3-9 show various views of the bed alert device.

### DETAILED DESCRIPTION

Before the present subject matter is further described, it is to be understood that this subject mater described herein is not limited to the particular embodiments described, as such may of course vary. It is also to be understood that the language used herein is for the purpose of describing particular embodiments only, and is not intended to be limiting. Unless defined otherwise, all technical terms used herein have the same meaning as commonly understood by one skilled in the art to which this subject matter belongs.

As will be apparent to those of skill in the art upon reading this disclosure, each of the individual embodiments described and illustrated herein has discrete components and features which may be readily separated from or combined with the features of any of the other several embodiments without departing from the scope of the subject described herein. Any recited method can be carried out in the order of events recited or in any other order which is logically possible.

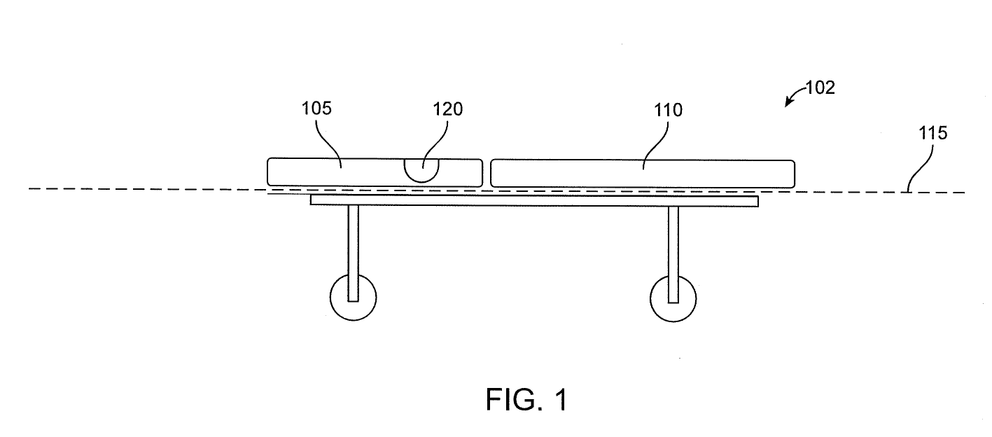

FIG. 1 shows a schematic view of a bed 102 having a head region 105 and a foot region 110, as will be known to those skilled in the art. The bed 102 is of the type such that at least a portion of the bed, typically the head region 105, may be elevated and positioned at any of a variety of angles relative to a horizontal plane 115. In this regard, the angle of the head region 105 is with respect to a plane on which the patient's upper body lies on the head region 105 relative to the horizontal. The bed 102 may include any of a variety of components typically associated with a bed, including a mattress, a frame, etc. It is possible that in some applications the bed will be frameless or have internal support structures and thus the central unit will be affixed to the mattress itself.

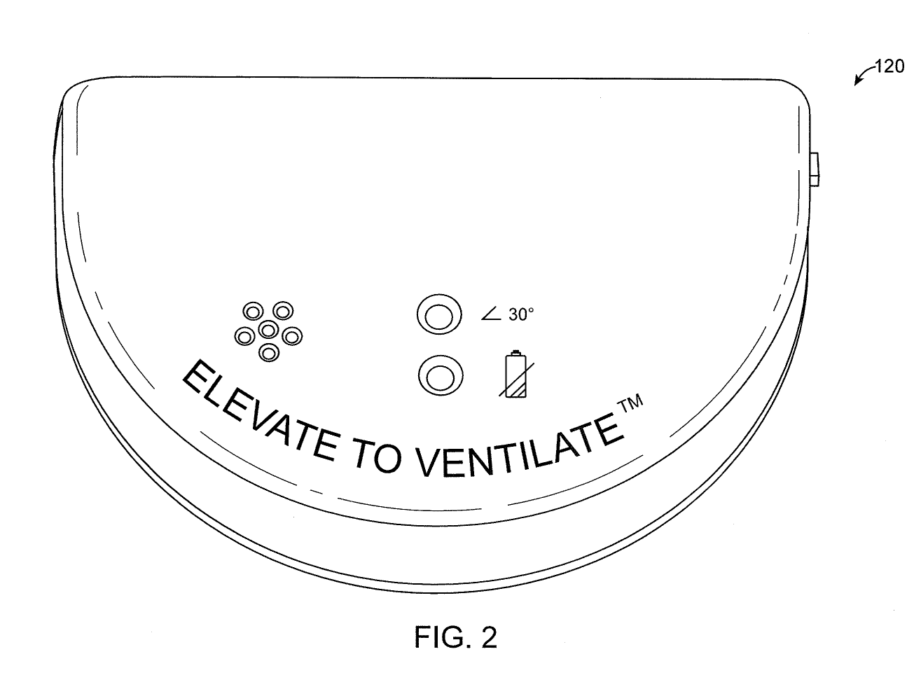

An alert device 120 is positioned on the bed, such as on the head region 105. The alert device 120 is configured to detect or otherwise measure the angle orientation of the head region 105 such as relative to the horizontal plane 115, as described in detail below. The alert device 120 is configured to provide an alert when the angle orientation of the head region falls outside a predetermined value or range of values. The alert may be any audio, visual, tactile, etc. means of notifying a user as to an alarm condition. FIG. 2 shows a front view of an exemplary embodiment of the alert device 120. The alert device 120 generally includes an outer housing that is substantially semi-circular-shaped when viewed from the front. The alert device may include one or more speakers, lights, or any other indicator of an alarm.

In an embodiment, the portable head of bed alert device mounts to essentially any bed (such as a hospital patient bed) and is configured to visually and/or audibly alert a caregiver when the head region 120 of the bed is at or outside a predetermined angle, such as 29 degrees, or below relative to the horizontal plane 115, which is perpendicular to the gradient of the gravity field.

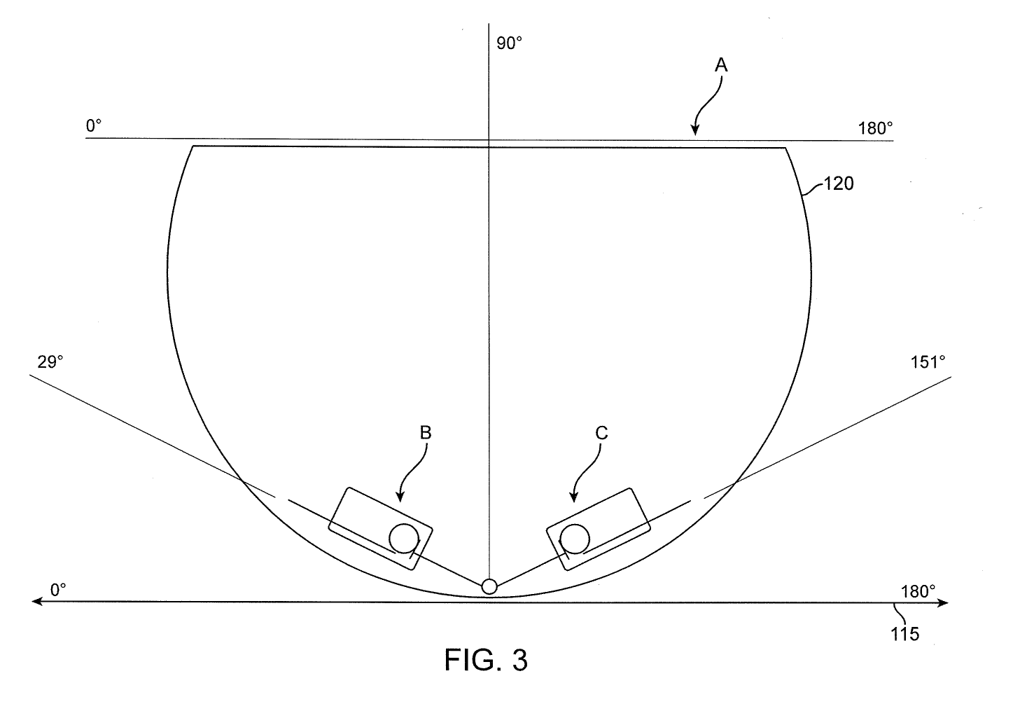

In an embodiment shown in FIG. 3, the device 120 includes one or more devices configured to measure or react to an angular orientation. In an embodiment, the device includes one or more tilt switches (B, C), such as ball, mercury, optical, pendulum or others. The switches are fixed at predetermined angles, such as at 29 degrees and 151 degrees opposite of each other, inside the device housing and relative to a horizontal visual plane of the housing (A in FIG. 3). The tilt switches are configured to open or close depending on the angle at which the switch is oriented. This allows the device to be mounted on the head region of the bed and to activate an alarm based upon the angle of the head region. It should be appreciated that the angles of 29 and 51 degrees are desirable but that the device is not limited to use with these particular angles.

The configuration of the tilt switches may vary. In an embodiment, the switches are coupled to one or more printed circuit boards that include relevant electronic components, such as for wireless communication. The circuit board is positioned inside the device housing.

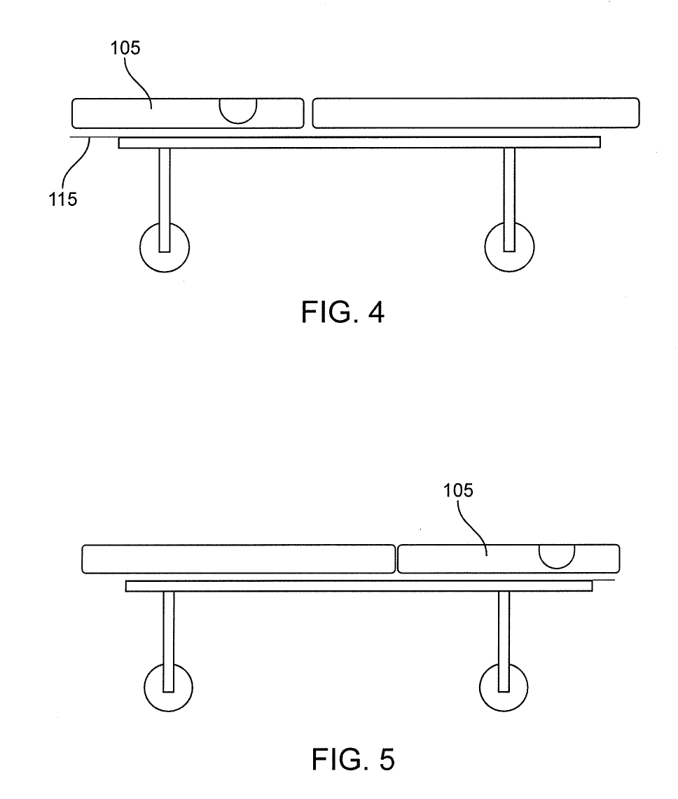

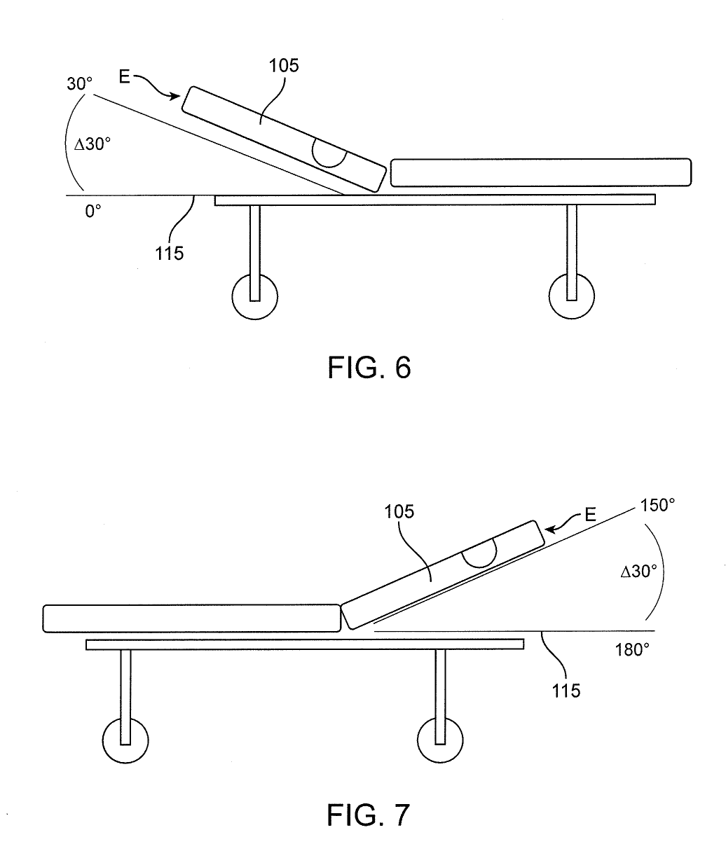

The device 120 can be mounted on either lateral side of the upper portion (i.e., head region 102) of the bed. When the device's visual plane A is positioned horizontally (or at another predetermined angle) both switches activate the device to audibly and visually alert the caregiver. FIGS. 1 through 7 illustrate an embodiment and use that activates the audible and visual alert by closing an electronic circuit; however, it is also noted that this is one example for illustration only and that other embodiments of the portable head of bed alert device employ conditions where the circuit opening activates the audible and visual alert.

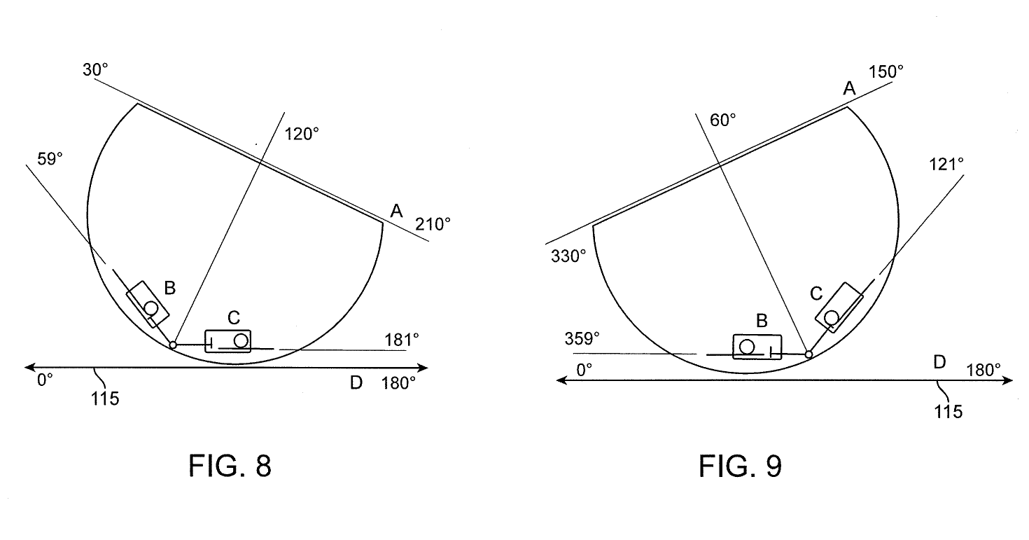

The portable head of bed alert device 120 may initially be securely mounted to the head region 102 of the bed with the head region 102 of bed in a horizontal flat position to assure parallel alignment to the device's horizontal plane 115. When the head region 102 of bed is elevated to a predetermined angle (such as, for example, 30 degrees or greater), one side of the portable head of bed alert device is elevated and the other side depressed (FIG. 8 or 9) relative to the horizontal plane 115 causing one of the two switches to fall below 0 (359 degrees) or 180 (181 degrees) degrees horizontal, resulting in opening of the circuit thus terminating the audible and/or visual alert. Thus, the alert is not emitted or is terminated when the head region is within the desired angle range or at the desired angle.

In an embodiment the portable head of bed alert device 120 includes an enclosure or housing capable of securely mounting to the head region 102 of the bed, and housing tilt switches fixed at 29 and 151 degrees, for example, relative to the device's horizontal plane 115 that are capable of opening or closing an electronic circuit to provide audible or visual alerts or alarms when a condition results.

In an embodiment the portable head of bed alert device includes an enclosure or housing, capable of securely mounting to the head region of the bed, and housing tilt switches fixed at 29 and 151 degrees relative to the device's horizontal plane, that are capable of opening or closing an electronic circuit to provide audible or visual alerts or alarms when the head of bed, being parallel to the devices visual plane, is 29 degrees or less relative to a horizontal plane of gravity.

In an embodiment the portable head of bed alert device 120 contains an on and off switch to turn the device on and off. The device 120 may include any of a variety of means configured to alert a user to an alarm condition, including a low battery condition. The alarm may be an intermittent or interrupted or variable patterned audible alert or alarm signal. The device 120 may emit an alarm signal, either or by wired or wireless means to an external device which provides the visual or audible alert or alarm. The alarm signal may be emitted independent of the amount of time that the alarm condition existed

The user may silence the alarm condition by actuating the device 120. In an embodiment the portable head of bed alert device allows the user to inactivate the audible or visual alert or alarm, such as by pressing a button or switch. The portable head of bed alert device also allows the user to reset the audible and visual alert or alarm.

In an embodiment the portable head of bed alert device communicates a signal and or data via a wired connection system such as a USB, Firewire, RS232, Ethernet, phone or analog interface to an external device. In an embodiment the portable head of bed alert device emits a wireless signal such as Bluetooth, radio frequency, 3G, wireless variable band, cell phone or satellite based technology, to an external device to provide an audible and or visual alert or alarm, and or transmits data to a monitor.

In an embodiment the portable head of bed alert device records the amount of time the head of bed has been 30 degrees or above and transmits this data to an external device, such as a monitor. In an embodiment the portable head of bed alert device contains a visible bubble level on its horizontal plane to allow the user to reasonably assure during mounting that the head of bed plane is parallel to the device's horizontal plane. In an embodiment the portable head of bed alert device's housing is made of material adapted and configured to glow in the dark. In an embodiment the portable head of bed alert device includes an enclosure or housing capable of securely mounting to the head of the bed, and housing tilt switches fixed at predetermined angles (such as 29 and 151 degrees) relative to the device's horizontal plane that are capable of opening or closing an electronic circuit to provide audible or visual alerts or alarms when a condition results.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results

Although embodiments of various methods and devices are described herein in detail with reference to certain versions, it should be appreciated that other versions, embodiments, methods of use, and combinations thereof are also possible. Therefore the spirit and scope of the appended claims should not be limited to the description of the embodiments contained herein.

1. A bed alert device, comprising:
a housing adapted to be removably attached to a patient support member, wherein the patient support member includes a support region that is movable between multiple angular orientations;
an angle measurement member coupled to the housing and configured to measure the angular orientation of the support region; and
an alarm emitter coupled to the angle measurement member and configured to emit an alarm when the angular orientation falls outside a predetermined angle.

2. A device as in claim 1, wherein the angle measurement member is a tilt switch.

3. A device as in claim 2, wherein the tilt switch is at least one of a ball, mercury, optical, and pendulum switch.

4. A device as in claim 2, wherein the tilt switch is coupled to a circuit board.

5. A device as in claim 4, wherein the housing contains the circuit board and tilt switch.

6. A device as in claim 1, wherein the patient support device is a bed. A device as in claim 1, wherein the support region is a head region.

8. A device as in claim 1, wherein the alarm emitter emits an alarm when the angular orientation falls outside a range of angles.

9. A device as in claim 1, wherein the predetermined angle is 30 degrees relative to a horizontal plane.

10. A device as in claim 1, wherein the alarm emitter emits an alarm when the angular orientation falls below 30 degrees relative to a horizontal plane.

11. A device as in claim 1, wherein the alarm is an audio alarm.

12. A device as in claim 1, wherein the alarm is a visual alarm.
